(19) United States
(12) Patent Application Publication
(10) Pub. No.: US 2012/0013089 A1
(43) Pub. Date: Jan. 19, 2012

(54) ARTICLE CARRYING SCOOTER

(76) Inventor: Kyle Reeves, Parksville (CA)

(21) Appl. No.: 13/033,139

(22) Filed: Feb. 23, 2011

(30) Foreign Application Priority Data
Oct. 7, 2010 (CA) 2,717,158

(51) Int. Cl. B62B 1/04

(52) U.S. Cl. 280/47.26

(57) ABSTRACT

An article carrying scooter with unique folding and backpack carrying capability. A track extends from a bottom toward a top on a back face of a body. A scooter platform has a track engagement for moving along the track. By sliding the track engagement along the track, the scooter platform is movable between a substantially horizontal operative position extending rearwardly from the back face of the body and a substantially vertical stored position parallel to the back face of the body. The scooter has a lower support which projects forwardly from a front face of the body, supporting a body of a backpack from below and an upper strap engaging backpack support that engages straps of a backpack to prevent forward movement of the backpack.

### FIELD

There is a described a scooter which was developed to carry a standard backpack, but which may also be used to carry small pieces of luggage and other articles.

### BACKGROUND

There are a number of issued patents and published patent applications that disclose scooters capable of carrying articles or scooter/backpack combinations. In order of publication, these include: PCT Patent Publication WO 03/045185 (Hammerfahr) entitled “Transport Device For Luggage Items or Similar”; U.S. Pat. No. 6,460,866 (Altschul et al) entitled “Combination Wheeled Vehicle and Article Carrier”; U.S. Patent Application Publication 2004/0056442 (Ostrowski et al) entitled “Baggage Scooter” and U.S. Pat. No. 7,431,311 (Turner et al) entitled “Combination Scooter/Backpack”.

### SUMMARY

There is described an article carrying scooter that has an upwardly oriented elongated body with a top, a bottom, a front face defining a forward direction and a back face defining a rearward direction. At least one wheel extends below the bottom of the body and is rotatable about a transverse horizontal rotational axis. This enables the body to be rolled in the forward direction or the rearward direction along a surface. An extendible non-rotatable handle is vertically extendible and retractable relative to the top of the body. A scooter platform is provided for standing upon. The scooter platform has a substantially horizontal orientation extending rearwardly from the back face of the body with at least one depending fixed position scooter wheel rotatable about a transverse horizontal rotational axis. There are a number of unique aspects that are incorporated into the article carrying scooter.

One unique aspect is the manner in which the scooter folds to a stored position. A track extends from the bottom toward the top on the back face of the body. The scooter platform has a first end and a second end. The first end has a track engagement for moving along the track. The second end has the at least one depending fixed position scooter wheel. By sliding the track engagement along the track, the scooter platform is movable between a substantially horizontal operative position extending rearwardly from the back face of the body and a substantially vertical stored position parallel to the back face of the body.

Another unique aspect is the manner in which the scooter supports a backpack. A lower support projects forwardly from the front face of the body, supporting a body of a backpack from below. An upper strap engaging backpack support is positioned at the top of the body. The upper strap engaging backpack support engages straps of a backpack to prevent forward movement of the backpack. It is envisaged the the scooter will, in most cases, be “built in” to a backpack by the manufacturer to form a scooter/backpack combination. However, the scooter may also be sold without a backpack and a standard backpack placed by the purchaser onto the scooter using the lower support and the upper strap engaging support.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of an article carrying scooter.

FIG. 2 is a front view of the article carrying scooter with the handle retracted.

FIG. 3 is a front view of the article carrying scooter with the handle partially extended.

FIG. 4 is a front view of the article carrying scooter with the handle fully extended.

FIG. 5 is a side elevation view of the article carrying scooter in a substantially horizontal operative position.

FIG. 6 is a side elevation view of the article carrying scooter in a position sliding along the track.

FIG. 7 is a side elevation view of the article in another position sliding along the track.

FIG. 8 is a side elevation view of the article carrying scooter in the substantially vertical stored position.

FIG. 9 is a top plan view of the article carrying scooter.

FIG. 10 is a detailed perspective view of the female engagement and the male engagement.

FIG. 11 is is a detailed perspective view of the female engagement engaged with the male engagement.

FIG. 12 is a side elevation view of the article carrying scooter and backpack combination with a backpack in the scooter platform in the substantially horizontal operative position.

### DETAILED DESCRIPTION

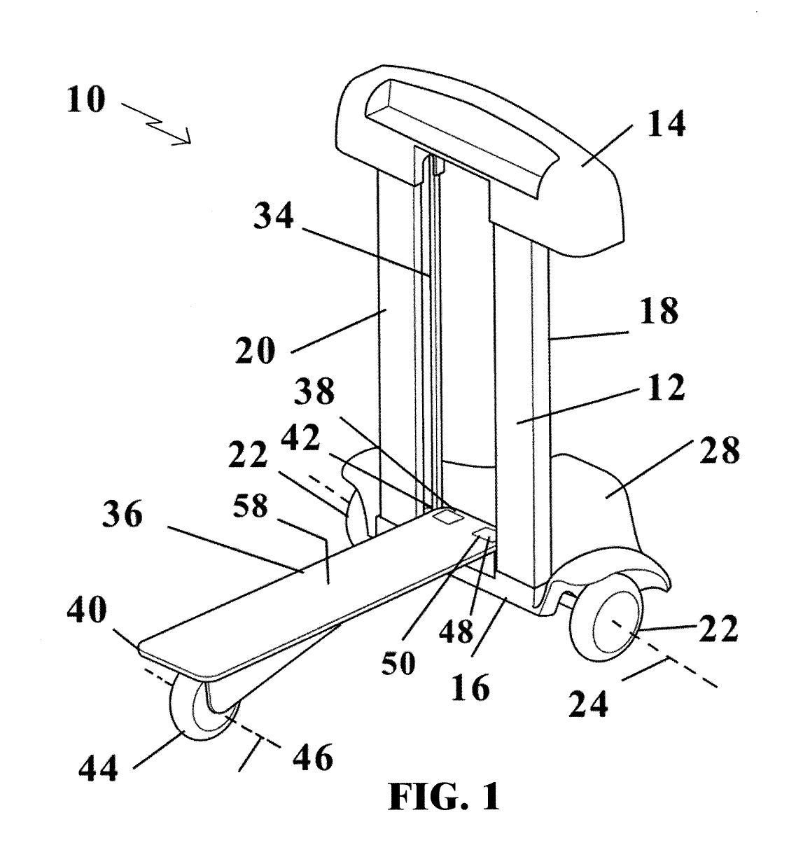

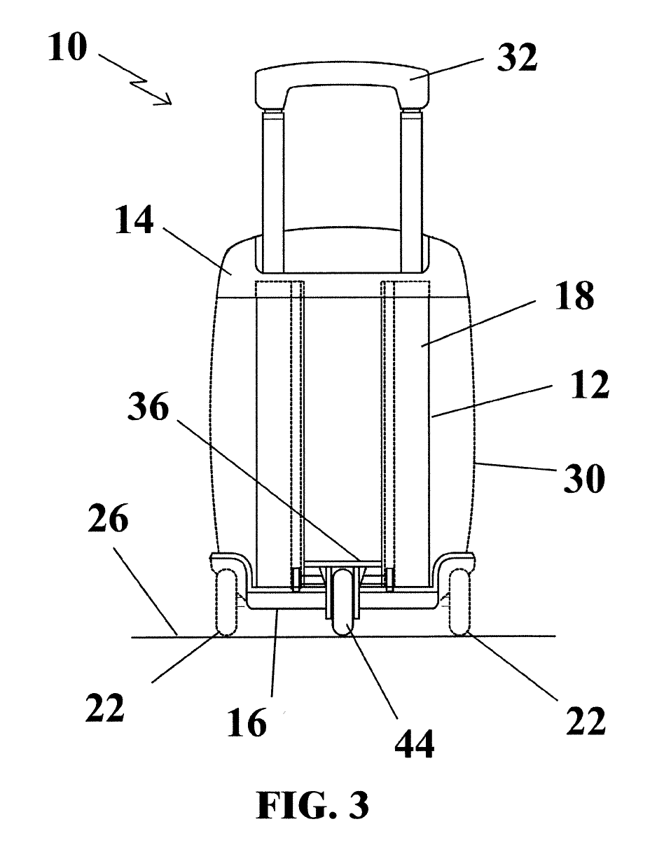

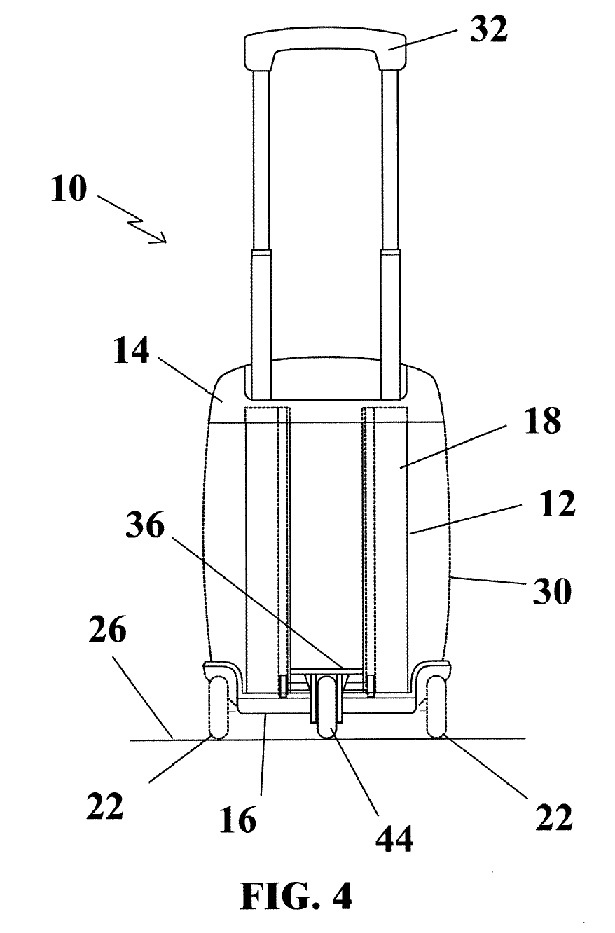

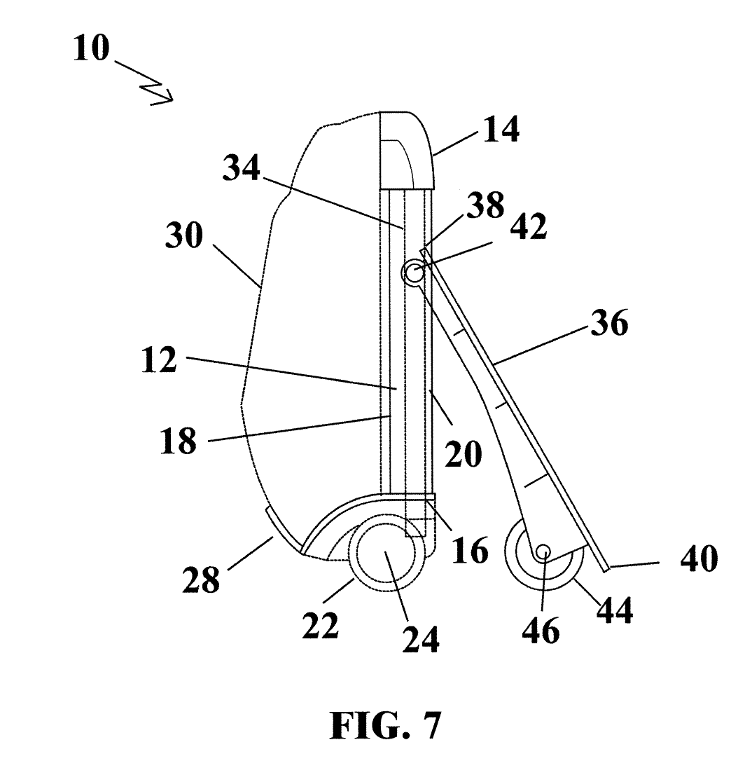

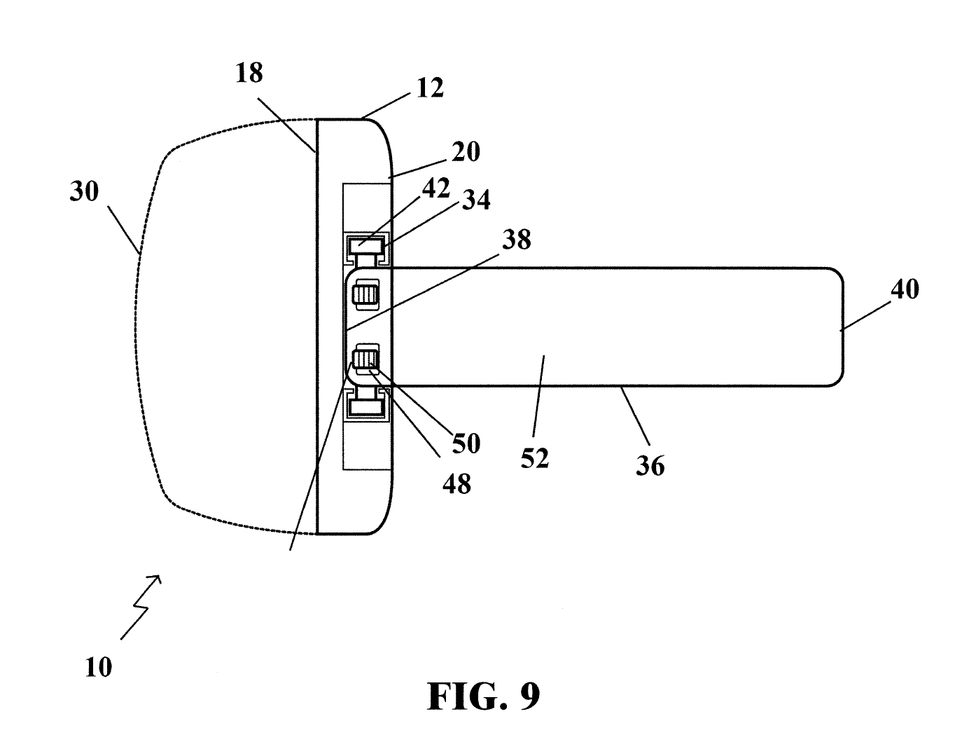

An an article carrying scooter, generally identified by reference numeral 10, will now be described with reference to FIG. 1 through 12.

### Structure and Relationship of Parts:

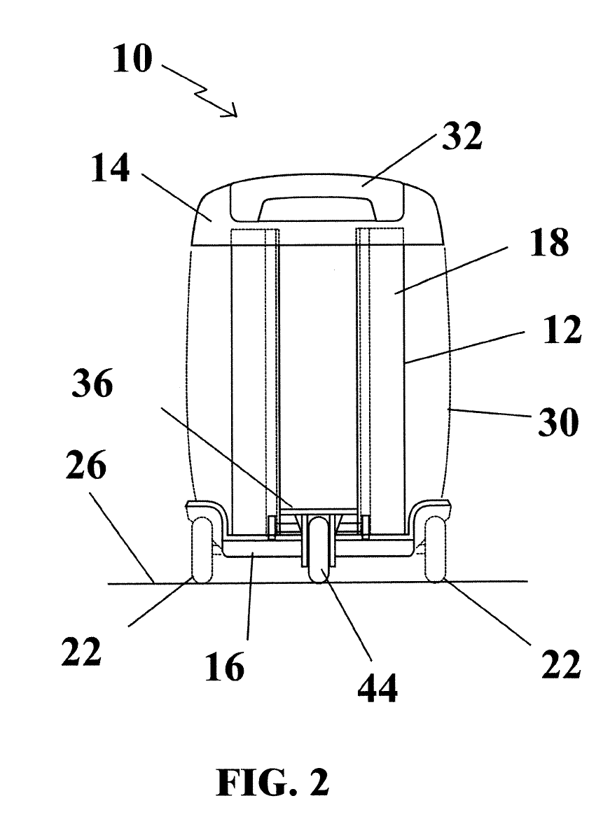

Referring to FIG. 1 there is illustrated an article carrying scooter generally reference by numeral 10. Article carrying scooter 10 has an upwardly oriented elongated body 12 that has a top 14 and a bottom 16. Referring to FIG. 2, body 12 also has a front face 18 which defines a forward direction and a back face 20 as illustrated in FIG. 1, which defines a rearward direction. Referring to FIG. 1, body 12 has two horizontally spaced wheels 22 extending below bottom 16 of body 12. Wheels 22 are rotatable about a transverse horizontal rotational axis 24, whereby body 12 is rolled in the forward direction or the rearward direction along a surface 26 illustrated in FIG. 2. While the illustrated embodiment 10, shows two wheels 22, it will be appreciated that there could be as few as one wheel 22 or more than two wheels 22.

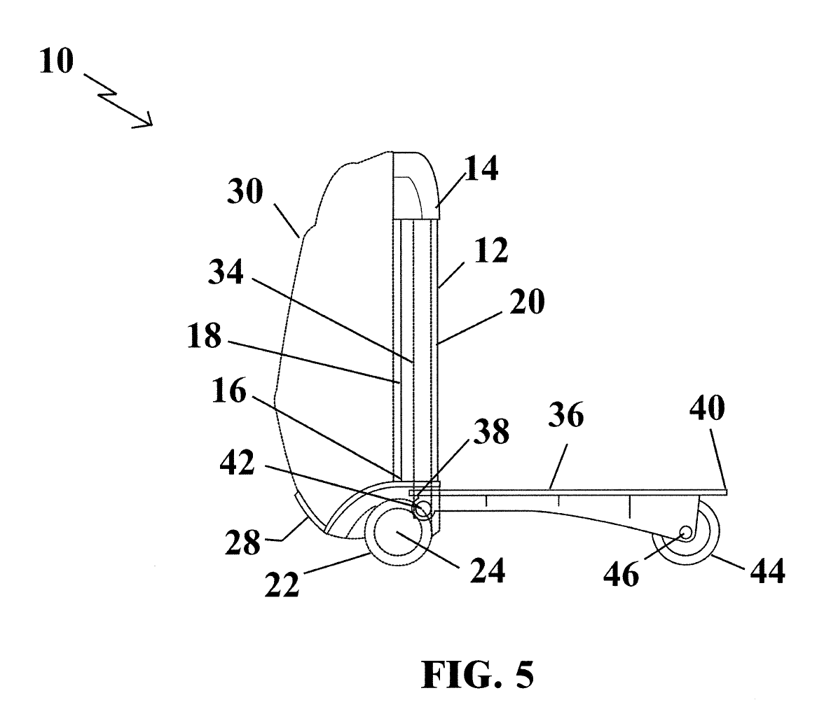

Referring to FIG. 1 and FIG. 5, a lower support 28 projects forwardly from front face 18 of body 12, whereby an article such as a backpack 30 which is being transported is supported from below. Referring to FIG. 2 through FIG. 5, an extendible non-rotatable handle 32 is provided which is vertically extendible and retractable relative to top 14 of body 12.

Referring to FIG. 1, a track 34 extends from bottom 16 toward top 14 on back face 20 of body 12.

Referring to FIG. 1, a scooter platform 36 is provided for standing upon. Scooter platform 36 has a first end 38 and a second end 40. First end 38 has a track engagement 42 for moving along track 34. Second end 40 has at least one depending fixed position scooter wheel 44 rotatable about a transverse horizontal rotational axis 46.

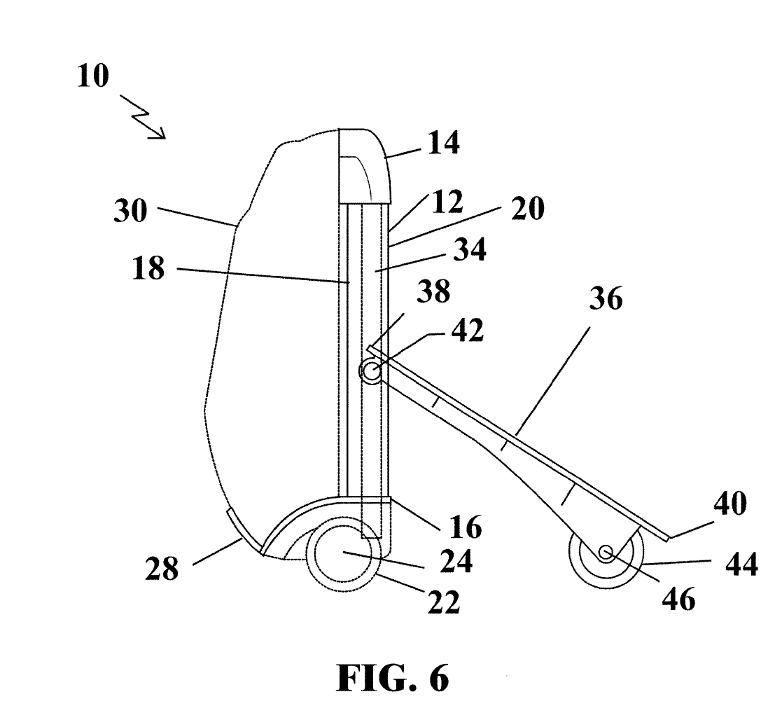

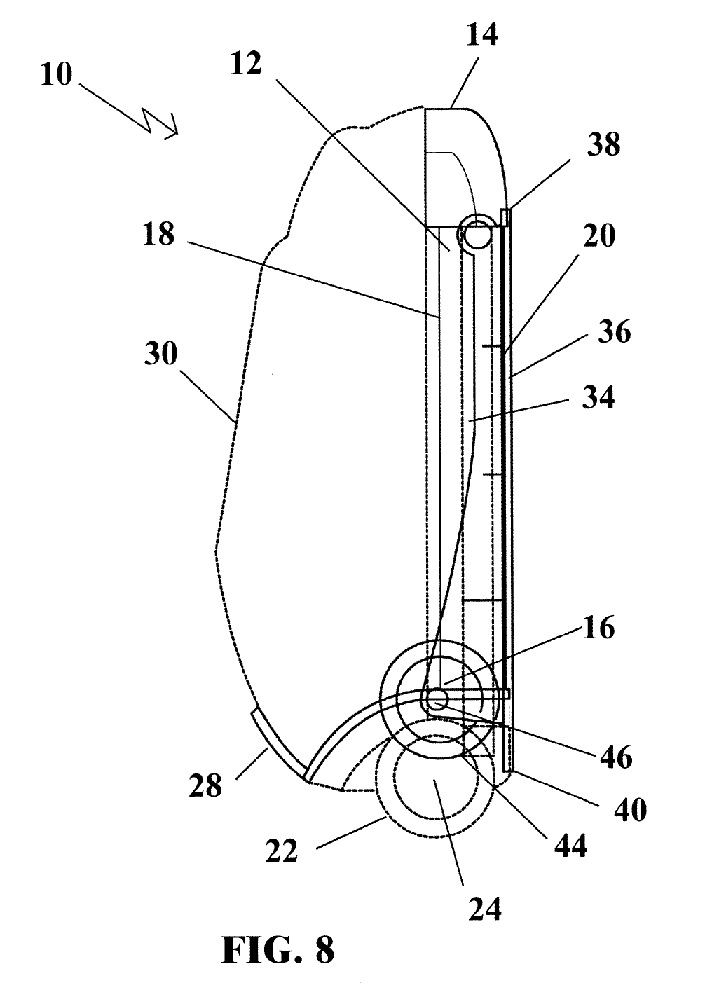

Referring to FIG. 1, by sliding track engagement 42 along track 34, scooter platform 36 is movable between a substantially horizontal operative position extending rearwardly from back face 20 of body 12 as illustrated in FIG. 5 and a substantially vertical stored position parallel to back face 20 of body 12 as illustrated in FIG. 8. FIG. 6 and FIG.

7 illustrate scooter platform 26 in movement positions as scooter platform 36 is being moved between substantially horizontal operative position extending rearwardly from back face 20 of body 12 as illustrated in FIG. 5 and a substantially vertical stored position parallel to back face 20 of body 12 as illustrated in FIG. 8.

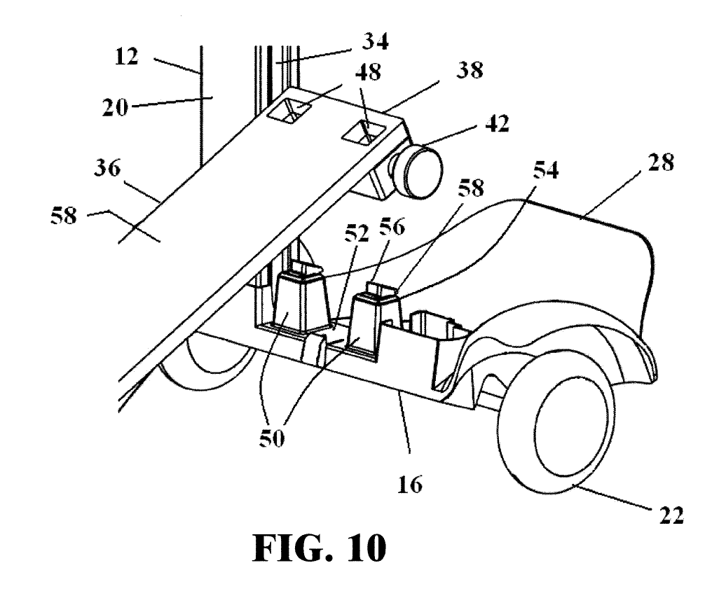

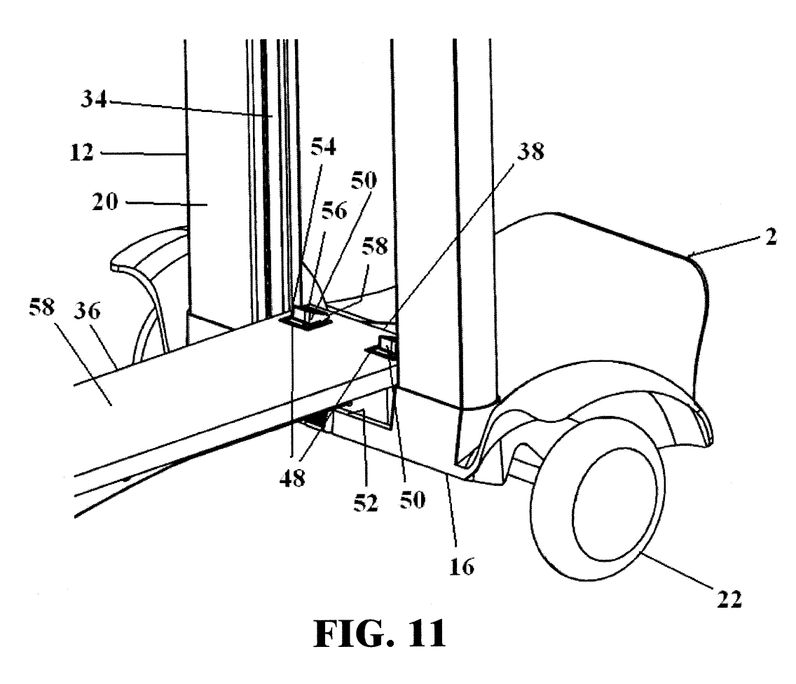

Referring to FIG. 10, a female engagement 48 is provided at first end 38 of scooter platform 36 and male engagement 50 projects upwardly from a bottom end 52 of track 34. Female engagement 48 is brought into mating engagement with male engagement 50 when scooter platform 36 is in operative position as illustrated in FIG. 11.

Referring to FIG. 10 male engagement 50 has an upper end 54 with a transversely projecting catch 56 that prevents male engagement 50 from being withdrawn from female engagement 48. Male engagement 50 has an eccentric off-center bias 58 to bring catch 56 into engagement with an upper surface 58 of scooter platform 36 until eccentric off-center bias 58 is manually overridden to release catch 56 so that male engagement 50 may be withdrawn from female engagement 48.

### Operation:

Referring to FIG. 1, when a user wishes to use article carrying scooter 10 for transportation, track engagement 42 can be slid along track 34 to move scooter platform 36 to substantially horizontal operative position extending rearwardly from back face 20 of body 12 and bringing female engagement 48 into mating engagement with male engagement 50. Referring to FIG. 2 through FIG. 4, extendible non-rotatable handle 32 is vertically extended relative to top 14 of body 12. Referring to FIG. 5, in the substantially horizontal operative position, scooter platform 36 is then rideable by the user. User can stand on scooter platform 36 with one foot and use his other foot to propel the article carrying scooter 10 in the desired direction while grasping extendible non-rotatable handle 32. Referring to FIG. 5 through FIG. 8, when article carrying scooter is no longer required for transport, and it is desirable to store it, then track engagement 42 can be slid along track 34 to move scooter platform 36 to a substantially vertical stored position parallel to back face 20 of body 12 and female engagement 48 is disengaged from male engagement 50 by manually overriding eccentric off-center bias 58 to release catch 56 so that male engagement 50 may be withdrawn from female engagement 48 as illustrated in FIG. 10 and FIG. 11. Referring to FIG. 2 through FIG. 4, extendible non-rotatable handle 32 can be retracted relative to top 14 of body 12.

### ALTERNATIVE EMBODIMENTS

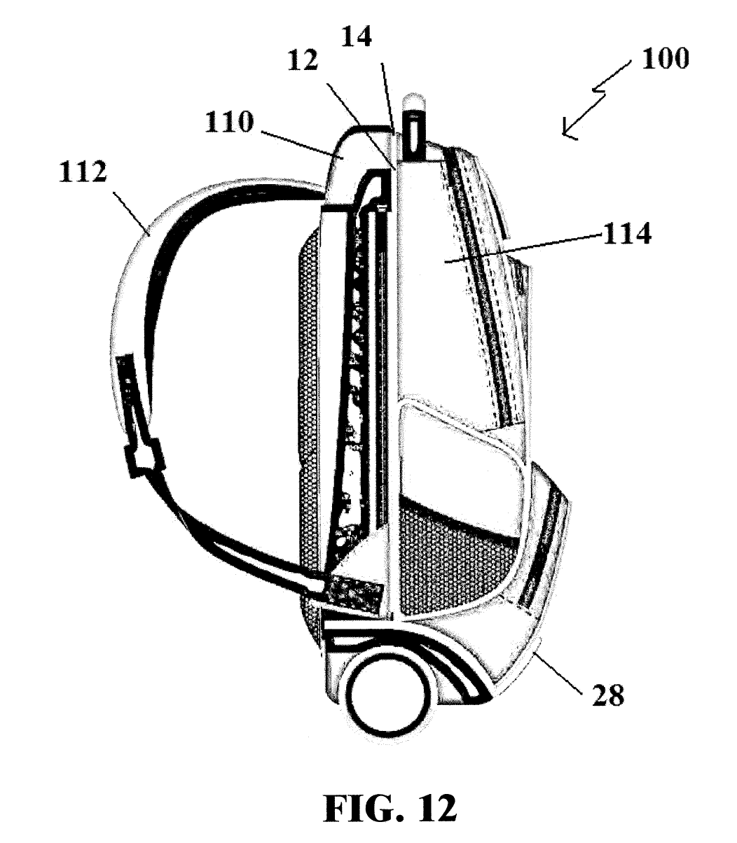

Referring to FIG. 12, there is illustrated a scooter and backpack combination generally referenced by numeral 100. In combination embodiment 100, body 12 is built into the backpack forming scooter and backpack combination 100. An upper strap engaging backpack support 110 is positioned at top 14 of body 12, whereby straps 112 of a backpack 114 are engaged to prevent forward movement of backpack 114. It will be appreciated that while the illustrated embodiment shows body 12 as forming a scooter and backpack combination 100, article carrying scooter 10 may also be sold without backpack 114 and a standard backpack or other type of carrying bag, can placed by the purchaser onto article carrying scooter 10 using lower support 28 and upper strap engaging support 110.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

1. An article carrying scooter, comprising:
an upwardly oriented elongated body having a top, a bottom, a front face defining a forward direction and a back face defining a rearward direction;
at least one wheel extending below the bottom of the body and rotatable about a transverse horizontal rotational axis, whereby the body is rolled in the forward direction or the rearward direction along a surface;
a lower support projecting forwardly from the front face of the body, whereby an article to be transported is supported from below;
an extendible non-rotatable handle vertically extendible and retractable relative to the top of the body;
a track extending from the bottom toward the top on the back face of the body;
a scooter platform for standing upon, the scooter platform having a first end and a second end, the first end having a track engagement for moving along the track, the second end having at least one depending fixed position scooter wheel rotatable about a transverse horizontal rotational axis, by sliding the track engagement along the track the scooter platform is movable between a substantially horizontal operative position extending rearwardly from the back face of the body and a substantially vertical stored position parallel to the back face of the body.

2. The article carrying scooter of claim 1, wherein the body has two horizontally spaced wheels.

3. The article carrying scooter of claim 1, wherein an upper strap engaging backpack support is positioned at the top of the body, whereby straps of a backpack are engaged to prevent forward movement of the backpack.

4. The article carrying scooter of claim 3, wherein the body is built into the backpack forming a scooter and backpack combination.

5. The article carrying scooter of claim 1, wherein one of a female engagement or male engagement is provided at the first end of the scooter platform and another of a female engagement or male engagement is provided at a bottom end of the track, the female engagement being brought into mating engagement with the male engagement when the scooter platform is in the operative position.

6. The article carrying scooter of claim 5, wherein the female engagement is at the first end of the scooter platform and the male engagement projects upwardly from the bottom end of the track.

7. The article carrying scooter of claim 6, wherein the male engagement has an upper end with a transversely projecting catch that prevents the male engagement from being withdrawn from the female engagement, the male engagement having an eccentric off-center bias to bring the catch into engagement with an upper surface of the scooter platform until the eccentric off-center bias is manually overridden to release the catch so that the male engagement may be withdrawn from the female engagement.

8. An article carrying scooter, comprising:
an upwardly oriented elongated body having a top, a bottom, a front face defining a forward direction and a back face defining a rearward direction;
a least one wheel extending below the bottom of the body and rotatable about a transverse horizontal rotational axis, whereby the body is rolled in the forward direction or the rearward direction along a surface;
a lower support projecting forwardly from the front face of the body, whereby a body of a backpack is supported from below, the backpack being secured to the lower support solely by its own weight;
an upper strap engaging backpack support positioned at the top of the body, whereby straps of the backpack are engaged to prevent forward movement of the backpack, the backpack being secured to the upper support solely by its own weight;
an extendible non-rotatable handle vertically extendible and retractable relative to the top of the body; and
a scooter platform for standing upon, the scooter platform having an operative position extending rearwardly from the back face of the body with at least one depending fixed position scooter wheel rotatable about a transverse horizontal rotational axis.

9. The article carrying scooter of claim 6, wherein:
a track extends from the bottom toward the top on the back face of the body; and
the scooter platform has a first end and a second end, the first end having a track engagement for moving along the track, the second end having the at least one depending fixed position scooter wheel, by sliding the track engagement along the track the scooter platform is movable between the operative position extending rearwardly from the back face of the body and a substantially vertical stored position parallel to the back face of the body.

10. The article carrying scooter of claim 6, wherein the body has two horizontally spaced wheels.
